(19) United States
(12) Patent Application Publication
(10) Pub. No.: US 2019/0155966 A1
(43) Pub. Date: May 23, 2019

(54) COMPUTER-IMPLEMENTED SYNTHESIS OF A MECHANICAL STRUCTURE USING A DIVERGENT SEARCH ALGORITHM IN CONJUNCTION WITH A CONVERGENT SEARCH ALGORITHM

(71) Applicant: AUTODESK, INC., San Rafael, CA (US)

(72) Inventors: Mehdi NOURBAKHSH, Richmond, CA (US); Adrian BUTSCHER, Toronto (CA); Hooman SHAYANI, London (GB)

(21) Appl. No.: 16/192,657

(22) Filed: Nov. 15, 2018

Related U.S. Application Data
(60) Provisional application No. 62/588,104, filed on Nov. 17, 2017.

(51) Int. Cl. G06F 17/50

(52) U.S. Cl. CPC G06F 17/5004; G06F 2217/06; G06F 2217/08

(57) ABSTRACT

One embodiment of the present invention sets forth a technique for generating one or more designs for a structural frame, the method comprising: receiving an input frame and an optimization objective that indicates a design goal for the one or more designs; based on the input frame, generating multiple candidate frames via a divergent search algorithm; based on the optimization objective, generating a different solution frame for each candidate frame via a convergent search algorithm; and determining a quality factor for each solution frame that enables a quantitative comparison with respect to the optimization objective of the solution frame with each other solution frame.

### CROSS-REFERENCE TO RELATED APPLICATIONS

This application claims priority benefit of the United States Provisional Patent Application titled, “TECHNIQUES FOR FRAME OPTIMIZATION,” filed on Nov. 17, 2017 and having Ser. No. 62/588,104. The subject matter of this related application is hereby incorporated herein by reference.

### BACKGROUND OF THE INVENTION

### Field of the Invention

The present invention relates generally to computer science and, more specifically, to computer-implemented synthesis of a mechanical structure using a divergent search algorithm in conjunction with a convergent search algorithm.

### Description of the Related Art

Computer-aided design (CAD) is the use of one or more computer systems to design, among other things, two-dimensional curves or figures and three-dimensional surfaces and solids. In addition, CAD can be used to integrate real-world manufacturing constraints and product performance requirements into the overall mechanical device and structure process. Thus, CAD is more than just design software; CAD can facilitate the creation, analysis, and optimization of mechanical and thermal structures and devices as well as visualization, imagination, and exploration of solutions. For example, given certain inputs, such as user-specified load conditions and geometric constraints, some CAD software programs can perform generative design operations, which are iterative design operations that ultimately generate one or more designs satisfying the user-specified constraints. A user can then sort through the generated designs and decide which to refine further.

In that regard, the generative design of structural frames typically implements optimization and convergent algorithms, such as topology optimization. Such algorithms generally converge to a single optimized solution. However, structural frames generated using these types of algorithms, particularly those generated with topology optimization algorithms, can have overly complex morphologies. For example, when optimizing a structure for weight, a large number of nodes may be used to generate an optimally light-weight structure that is significantly lighter than structures generated using fewer nodes. Because of the large number of nodes included in the optimally light-weight structure, however, the structure can be highly complex, even after applying an edge-pruning strategy during optimization. As a result, fabricating such structures can be complex or even impossible, unless additional supplemental manufacturing operations are performed. Thus, in certain cases, conventional generative design approaches generate designs for strong and light-weight structural frames that are difficult and expensive to manufacture.

As the foregoing illustrates, what is needed in the art are more effective ways to generate designs for structural frames.

### SUMMARY

One embodiment of the present invention sets forth a technique for generating one or more designs for a structural frame, the method comprising: receiving an input frame and an optimization objective that indicates a design goal for the one or more designs; based on the input frame, generating multiple candidate frames via a divergent search algorithm; based on the optimization objective, generating a different solution frame for each candidate frame via a convergent search algorithm; and determining a quality factor for each solution frame that enables a quantitative comparison with respect to the optimization objective of the solution frame with each other solution frame.

At least one advantage of the disclosed techniques is that a structural frame produced via a generative design process can have significantly fewer nodes than the frames used by a convergent algorithm included in the process. Consequently, candidate frames input to the convergent algorithm can have a large number of nodes, while the structural frame output by the convergent algorithm can have fewer nodes, and therefore be less complex in appearance and easier to fabricate. A further advantage is that the structural frame so produced is more likely than a structural frame generated with conventional generative design techniques to approximate a global minimum of the objective function used to optimize the frame design. Thus, for a specific input frame that is optimized for minimal weight, a structural frame produced by the disclosed techniques will be lighter-weight and/or can have fewer nodes and beams than a structural frame generated with conventional generative design techniques. Yet another advantage is that the divergent search can eliminate prospective solutions that are not manufacturable and/or violate certain feasibility conditions

### BRIEF DESCRIPTIONS OF THE DRAWINGS

FIG. 1 is a graph of a multi-modal objective function with a global minimum and a local minimum, according to various embodiments of the present invention.

FIG. 2 is a conceptual block diagram of a process for synthesizing a mechanical structure using a divergent search algorithm in conjunction with a convergent search algorithm, according to various embodiments of the present invention.

FIG. 3 sets forth a flowchart of method steps for generating candidate frames based on an input frame, according to various embodiments of the present invention.

FIG. 4 schematically illustrates the process of FIG. 2, according to various embodiments of the present invention.

FIG. 5 sets forth a flowchart of method steps for generating one or more designs for a structural frame, according to various embodiments of the present invention.

FIG. 6 is a block diagram of a computing device configured to implement one or more aspects of the present invention.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### Objective Functions in Generative Design

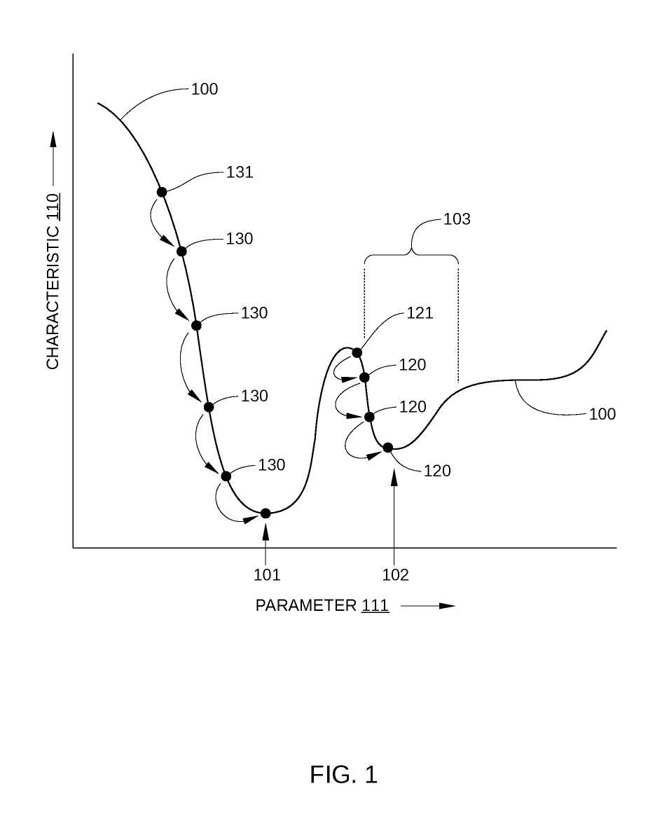

Traditional methods of generative design are often based solely on optimization and so-called convergent search algorithms that generally converge to a single optimized solution, such as topology optimization algorithms, fully stressed design (FSD) algorithms, and fully utilized design (FUD) algorithms. However, the optimization of complex physical problems (such as the design of a structural frame having many nodes, fixed supports, and/or geometric constraints) is rarely associated with a convex function. That is, the objective function for such problems can have a plurality of local minima. As a result, a convergent search algorithm may converge to an optimized solution that corresponds to a local minimum, missing the global minimum of the objective function that corresponds to significantly better solution. Thus, depending on the details of an input frame, a convergent search algorithm can converge to different solutions, as illustrated in FIG. 1.

FIG. 1 is a graph of a multi-modal objective function 100 with a global minimum 101 and a local minimum 102, according to various embodiments of the present invention. Multi-modal objective function 100 quantifiably expresses a value of a physical or other characteristic 110 of a design solution to a particular problem, such as weight, cost, peak temperature achieved during operation, etc., with respect to one or more optimization parameters 111 (only a single parameter is shown in FIG. 1). In the field of generative design, a convergent search algorithm, also referred to as a local search and optimization algorithm, is typically employed to minimize multi-modal objective function 100. That is, the convergent search algorithm is configured to find a design solution that coincides with a minimum of multi-modal objective function 100. Typically, the convergent search algorithm is a gradient-based algorithm that utilizes local information about the properties of multi-modal objective function 100 at one point (such as the first and second derivatives) to sequentially make small improvements towards a local minimum.

In many instances, a convergent search algorithm is unable to generate solutions beyond a basin of attraction 103 of local minimum 102. For example, in the context of frame design, iterative solutions 120 are generated sequentially by the convergent search algorithm when starting with a first input frame 121 as the initial solution to a structural frame problem, and iterative solutions 130 are generated sequentially by the convergent search algorithm when starting with a second input frame 131 as the initial solution to the problem. As shown, iterative solutions 120 converge to local minimum 102, while iterative solutions 130 converge to global minimum 101, where global minimum 101 better minimizes multi-modal objective function 100. Thus, depending on the initial solution provided to the convergent search algorithm, a significantly different solution may be generated.

### Frame Synthesis Process

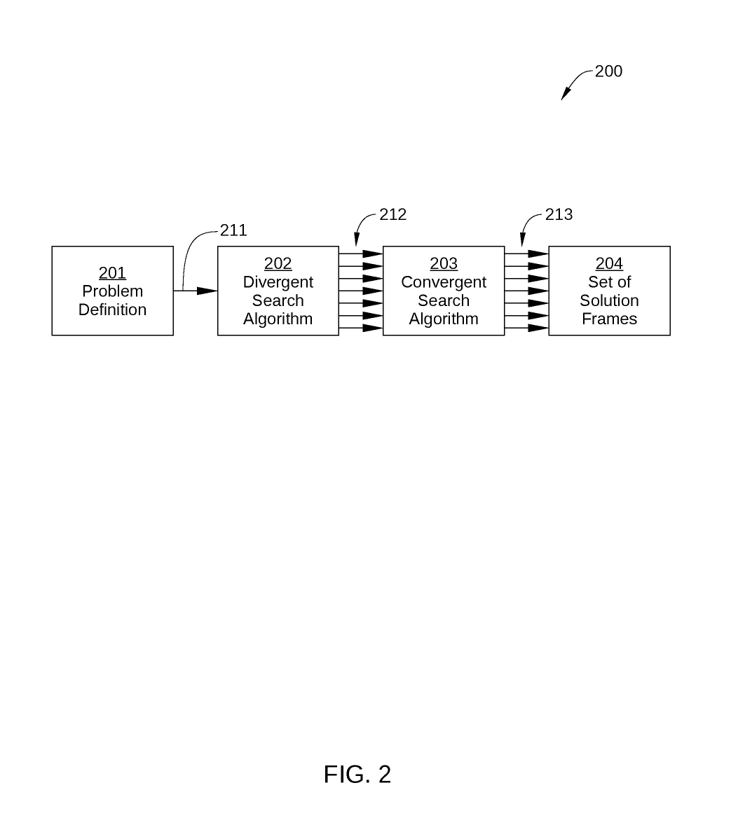

According to embodiments of the present invention, a divergent search algorithm is employed in conjunction with a convergent search algorithm, so that, for a particular objective function, a solution that corresponds to the global minimum of an objective function is produced. One such embodiment is illustrated in FIG. 2. FIG. 2 is a conceptual block diagram of a process 200 for synthesizing a structure frame using a divergent search algorithm in conjunction with a convergent search algorithm, according to various embodiments of the present invention. The output of process 200 can be a single frame design (or “frame”) that satisfies certain geometric, manufacturing, and/or other physical constraints. Alternatively, the output of process 200 can be a plurality of such frames. As shown, process 200 includes a problem definition 201, a divergent search algorithm 202, a convergent search algorithm 203, and a set of solution frames 204. The solution frames 213 generated by process 200 generally include node locations, beam (or edge) thicknesses, and the like, that together define a mechanical structure that satisfies the appropriate constraints and load requirements.

Problem definition 201 includes physical constraints of a design solution (geometric, equilibrium, stress, and other applicable constraints). In addition, problem definition 201 includes an input frame 211 as a starting point for process 200. Input frame 211 includes a collection of trusses connected at their endpoints by pin joints, either to each other or to fixed points (fixed supports) in space. In some embodiments, problem definition 201 further includes an optimization objective, which is typically user-selected and indicates the design goal for frames generated by process 200. For example, for a frame generated by process 200, user-selectable optimization objective can include a total weight of the frame, a cost of the frame, a heat transfer capability of the frame, and the like. Problem definition 201 may further include user-selectable parameters for divergent search algorithm 202, and/or convergent search algorithm 203.

### Divergent Search Algorithm

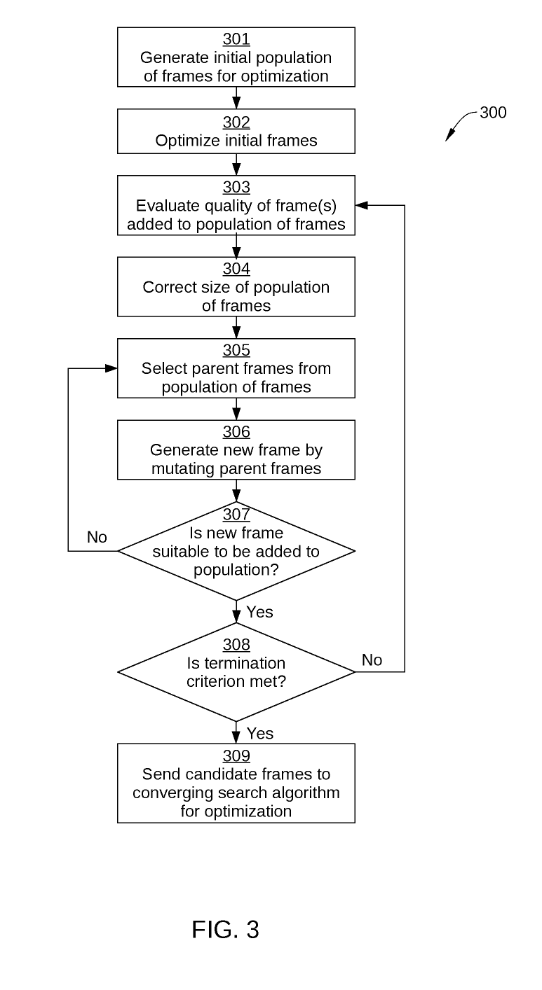

Divergent search algorithm 202 is configured to generate a plurality of frames based on input frame 211 from problem definition 201. In some embodiments, input frame 211 is generated externally to and received by divergent search algorithm 202, whereas in other embodiments, divergent search algorithm 202 receives information included in problem definition 201 and generates input frame 211. Divergent search algorithm 202 facilitates the exploration of the objective function associated with optimizing frames that meet the criteria set forth in problem definition 201. Thus, a global minimum of the objective function is more likely to be found than when employing conventional generative design techniques. Divergent search algorithm 202 can be any suitable non-converging algorithm that generates multiple topologies of candidate frames 212 from input frame 211. The candidate frames 212 are then subsequently optimized by convergent search algorithm 203 into more efficient and, in many instances, simpler solution frames 213. In some embodiments, divergent search algorithm 202 is an evolutionary algorithm that generates the multiple topologies of candidate frames 212. The basic operations of one such embodiment are described below in conjunction with FIG. 3.

FIG. 3 sets forth a flowchart of method steps for generating candidate frames based on an input frame, according to various embodiments of the present invention. Persons skilled in the art will understand that any system configured to perform the method steps, in any order, is within the scope of the present invention.

As shown, a method 300 begins at step 301, where divergent search algorithm 202 generates an initial population of frames based on input frame 211. In some embodiments, the initial population of frames is generated from a base frame, where a base frame is a fully connected frame of all the supported and loaded nodes. This base frame is created from the input frame by removing all the beams and all the optimizable nodes. Then all the remaining nodes (including supported or loaded nodes) are densely connected to each other using beams. This base frame is used as the basis for generating a number of random frames to fill the initial population. “Nodes,” as used herein, are connection points between two beams, and are not constrained to a specific fixed location, i.e., the nodes of a particular frame can be relocated during the course of the optimization process. By contrast, in some embodiments a fixed support is constrained to a predefined location, as set forth in problem definition 201. In other embodiments, the fixed supports can be relocated within a predetermined range.

In some embodiments, an approach for generating these initial frames is to add a random number of nodes to the base frame. These new nodes are positioned at random locations within the design space (for example, the geometry bounding box of the base frame) and are fully connected to each other and to all the nodes. In addition, in some embodiments, the cross-sectional areas of the beams of each of the initial frames are all initialized to a certain constant value, for example one.

In step 302, divergent search algorithm 202 optimizes each initial frame. In some embodiments, the initial frames are optimized via convergent search algorithm 203, which is described in greater detail below. In some embodiments, when convergent search algorithm 203 is employed in step 302, the convergence criteria for convergent search algorithm 203 may be significantly relaxed compared to when convergent search algorithm 203 is employed to generate solution frames 213.

In step 303, divergent search algorithm 202 evaluates the quality of the frame or frames being added to the current population of frames, for example by the determination of one or more quality metrics. Thus, after the initial frames have undergone the optimization process of step 302, one or more quality metrics are determined for each initial frame optimized in step 302. When a single new frame is added to the current population of frames (see steps 305-307), then one or more quality metrics are determined for the new frame generated in step 305, and the single new frame is added to the current population of frames.

In some embodiments, the quality metric determined in step 303 is based on the resultant objective function value (for example, volume, weight, cost, etc.) of each frame being evaluated. In addition, in some embodiments, the quality metric determined in step 303 is based on an aggregated constraint violation value for each frame being evaluated. Other suitable quality metrics of the frame(s) being evaluated may also be determined in step 303. The resultant objective function value, the aggregated constraint violation value, and values for any other suitable quality metric(s) can then be employed in quantitatively comparing frames in the current population of frames.

In step 304, divergent search algorithm 202 corrects the size of the population of frames. That is, when a new frame is generated and added to the current population, the population of frames is truncated to a threshold number of total frames. The frames that are truncated can be selected based on the above-described quality metrics of the frames.

In step 305, divergent search algorithm 202 selects parent frames from the current population of frames for generating a new frame. In some embodiments, frames are selected as parent frames via a random selection process, thereby maximizing exploration of the objective function being minimized, and increasing the potential for detecting the global minimum of the objective function. Thus, in such embodiments, parent frames are determined via a process that is not restricted to selection based on a quality metric of the parent frame. In other embodiments, frames can be selected as parent frames based on one or more of the above-described quality metrics of each frame in the population of frames. In such embodiments, frames that meet a certain quality threshold are eligible to be employed as parent frames, or a highest quality portion of the population of frames is eligible to be employed as a parent frame. In addition, in some embodiments, a frame is not considered eligible to be a parent frame if the frame too similar to another frame in the population that is already eligible to be a parent frame. For example, in such embodiments, a frame that has a similar volume, number of nodes, and number of edges as another frame in the population of frames is not considered eligible to be a parent frame.

In step 306, divergent search algorithm 202 generates a new frame by mutating a parent frame or frames. Any suitable mutation algorithm that incrementally modifies a parent frame selected from the population of frames can be employed in step 306. In some embodiments, a number of randomly located nodes is added to the parent frame, and the nodes are fully connected to every other node in the frame. Alternatively, in some embodiments, the randomly located nodes added to the parent frame can be connected to a selected portion of the other nodes in the frame, such as a randomly selected portion or a pseudo-randomly selected portion of the other nodes. Alternatively, in some embodiments, each randomly located nodes added to the parent frame can be connected to the k-nearest nodes to that node added to the parent frame, where k is a predetermined integer. Thus, in the above-described embodiments, the change or changes to the parent frame are determined via a process that is not restricted to selection based on a quality metric of the new frame. In addition, the randomly changed frames generated by this approach enables more extensive exploration of the objective function by creating randomly altered frames. This approach allows the creation of more complicated frames over generations of mutation, and leads to complexification.

In some embodiments, edges are removed from the frame. In such embodiments, the edges of the frame may be first sorted in ascending order of cross-sectional area, and the edge(s) that are removed are selected from thinnest edges of the frame. In some embodiments, the specific edges that are removed are randomly selected from the thinnest group of edges. Alternatively, in some embodiments, the specific edges that are removed are selected based on a probability that is inversely proportional with the thickness of each specific edge. Furthermore, in some embodiments, a parent frame is mutated by a combination of node addition and edge removal.

In step 307, divergent search algorithm 202 determines whether a new frame generated in step 306 is suitable for being added to the current population of frames. Thus, the new frame is evaluated, for example by determining one or more of the quality metrics described above in step 303. Alternatively, in some embodiments, cross-sectional areas of all the beams in the new mutated frame are reset to the certain constant value (for example one), and the new frame is sent to convergent search algorithm 203 to be optimized for volume minimization with respect to cross-sectional areas and force equilibrium constraints for a number of iterations. In such embodiments, a mutated and optimized frame is determined to be not suitable for addition to the current population when convergence is not achieved by convergent search algorithm 203. When convergence is achieved by convergent search algorithm 203, the resultant frame, which is an optimized frame, is determined to be suitable for addition to the current population. The volume of the optimized frame, or any other quality metric, is subsequently used to keep the population of frames sorted. In some embodiments, during the above-described optimization of the new frame, frame nodes that are stationary through a certain number of consecutive iterations and/or are located within a certain proximity threshold are merged with each other into a single node.

Alternatively or additionally, in some embodiments, divergent search algorithm 202 considers one or more other feasibility conditions and constraints in step 307, such as manufacturability, when determining whether a new frame generated in step 306 is suitable for being added to the current population of frames. For example, if a node or beam is located after convergent optimization in a region of design space that is already occupied by another object, the solution is considered infeasible and is not added to the current population of frames.

In step 307, when divergent search algorithm 202 determines that the new frame generated in step 306 is suitable for being added to the current population of frames, method 300 proceeds to step 308. When divergent search algorithm 202 determines that the new frame generated in step 306 is not suitable for being added to the current population of frames, method 300 returns back to step 305.

In step 308, divergent search algorithm 202 determines whether a termination criterion has been met for method 300. For example, in some embodiments, the termination criterion is a predetermined number of “generations” of mutation of the current population being completed. In such embodiments, one generation of mutation may be defined as the mutation of a certain portion of the population of frames being completed, the mutation of a certain number of individual frames being completed, and the like. Alternatively or additionally, in some embodiments, the termination criterion is based on meeting a certain acceptability criterion, such some or all of the current population of frames having a target volume, etc. Alternatively or additionally, in some embodiments, the termination criterion includes a temporal component, such as a calculation time limit.

In step 308, when divergent search algorithm 202 determines that the termination criterion has been met, method 300 proceeds to step 309. When divergent search algorithm 202 determines that the termination criterion has not been met, the newly optimized frame is added to the current population and method 300 returns back to step 303.

In step 309, divergent search algorithm 202 sends the candidate frames to converging search algorithm 203 for further optimization. In some embodiments, only a portion of the population of frames are selected as candidate frames, for example based on one or more of the quality metrics described in conjunction with step 303. In other embodiments, all of the frames in the population of frames are selected as candidate frames in step 309.

### Convergent Search Algorithm

Returning back to FIG. 2, convergent search algorithm 203 according to one embodiment is now described. Convergent search algorithm 203 receives candidate frames 212 from divergent search algorithm 202, and generates a solution frame 213 for each candidate frame 212 received. More specifically, for each candidate frame 212 received, convergent search algorithm 203 uses the gradients of the objective and constraint functions to adjust the cross-sectional areas of beam members and the locations of the endpoints of the beam members to minimize weight (or some other physical characteristic of the frame) while resisting a user-specified set of load conditions. In some embodiments, convergent search algorithm 203 is further configured to simplify the topology of a frame that is being optimized by merging closely located nodes and removing edges when possible.

In an example embodiment, to represent the geometry of a frame, in convergent search algorithm 203, the endpoints of the trusses (i.e., pinned-joint edges/beams) define a set of nodes that are points in space. The trusses themselves are specified by pairs of point, also known as edges. Thus, connectivity information Φ can be a data structure that includes a list of nodes N and edges E. The i^{th} node is assigned a location vᵢεR³, and to account for the physical dimension of the trusses, each edge (i,j)εE is assigned a positive cross-sectional area α_{(i,j)}εR. Nₒₚₜᵢ⊆N is defined as the subset of nodes whose placement in space we wish to determine using optimization. Nₛᵤₚₚₒᵣₜ⊆N is defined as the subset of nodes that are attached to fixed supports (such as the ground). It is assumed that Nₛᵤₚₚₒᵣₜ and Nₒₚₜᵢ do not share any elements in common.

In representing the physics of the load case or cases to be considered, forces are applied at certain nodes of a frame. Since, in the exemplary embodiment described herein, the trusses in the network are connected to each other by pin joints, each truss responds to the applied forces by extending or compressing in the axial directions only. As a consequence of Hooke's Law, reaction forces of tension or compression develop inside the trusses and at the attachment points of the support nodes, to balance the applied forces until the frame reaches a state of static equilibrium. A set of L load cases is defined with the following notation: For each 1≤l≤L, let N_{load} be the subset of nodes that are subject to loading. It is assumed that N_{load}, is disjoint from both Nₛᵤₚₚₒᵣₜ and Nₒₚₜᵢ, and for each node vᵢ with iεN_{load}ⁱ, let Pᵢ^{l}εR³ denote the force applied at that node.

In convergent search algorithm 203, a frame is considered to be optimal if the frame minimizes an objective function (at least locally) while satisfying various geometric and engineering constraints. Examples of one such objective function and various constraints that can be employed in convergent search algorithm 203 are described below.

In some embodiments, the optimization objective of convergent search algorithm 203 is to minimize the total volume of the frame. If all the trusses are made of the same material, then volume of the frame is directly proportional to the mass of frame (when neglecting the mass of the pin joints), and therefore can be employed as a proxy for the weight (or cost) of the frame. In terms of the connectivity, node locations, and edge cross-sectional areas, the total volume of the frame can be given by

$$Vol := {\sum }_{( i , j ) ∈ E} ‖ {v}_{i} - {v}_{i} ‖ {a}_{( i , j )} .$$

In some embodiments, connectivity Φ can be constrained by requiring that N contains support nodes N^{support} and the union of all the loaded nodes N_{load}ⁱ for 1≤l≤L. In addition, in some embodiments, the optimizable nodes can be constrained to lie within a design domain D⊆R³, such as vᵢεD for all iεNₒₚₜᵢ. Furthermore, the cross-sectional areas of the trusses are constrained to be positive.

In some embodiments, equilibrium constraints can be implemented as follows. Given that externally applied forces in each load case induce forces of tension and compression within the trusses, for the l^{th} load case, q_{(i,j)}^{l} denotes the magnitude of force in a truss along the edge v(i,j)εE. When this quantity is positive, the truss is in tension; when negative, the truss is in compression. Generally, forces emanating from all nodes (but not the support points) balance the external forces applied at those nodes. Any suitable constraint formulation implementing the above constraints can then be employed in convergent search algorithm 203.

In some embodiments, stress constraints can be implemented as follows. Since the trusses are composed of a physical material that can experience failure or breakage, the trusses cannot sustain arbitrarily large tensile and compressive stresses. Since stress is defined as force per unit area, the stress constraints can include user-prescribed thresholds derived from material maximum yields and safety factors. Any suitable constraint formulation implementing the above stress constraints can then be employed in convergent search algorithm 203.

In the embodiment of convergent search algorithm 203 described above, solution frames are 213 are generated in which nodes are connected to each other by pin joints. Embodiments of convergent search algorithm 203 configured to generate solution frames in which nodes are connected to each other by fixed joints can be readily devised by one of skill in the art upon reading the teachings set forth herein.

In some embodiments, other engineering constraints can also be considered in convergent search algorithm 203, such as allowable temperatures and the like. In some embodiments, other engineering constraints can also be considered in convergent search algorithm 203. For example, frame networks connected by fixed joints and subject to forces and torques could be modeled. To solve for an optimal network in this case, additional unknowns to the problem in the form of moment would be defined, and additional constraints in the form of a moment equilibrium constraint and a joint torque constraint would be included.

To solve the geometry optimization problem defined by the above constraints and objective function, a conventional algorithm, such as a sequential quadratic programming (SQP) algorithm can be employed by convergent search algorithm 203. Such an algorithm can be iterated for the optimization of a particular frame until a specific convergence criterion has been met.

In addition, in some embodiments, convergent search algorithm 203 is configured to perform topology manipulation while optimizing a solution for a particular frame. In such embodiments, convergent search algorithm 203 modifies the connectivity of the beams and nodes of the frame being optimized. That is, under certain conditions, beams are removed, and under other conditions, nodes are removed. Specifically, the location of nodes and thicknesses of beams at each iteration of optimization are tracked. In some embodiments, the connectivity modification algorithm includes merging two nodes that have settled in close proximity to each other over multiple iterations. For example, when the movement of a particular node from one iteration to another drops below a certain threshold, the node is considered to be a stationary node. When stationary nodes are disposed within a certain threshold distance from each other, the stationary nodes are merged together. In such embodiments, the resultant node can be located at, for example, the centroid of the group of stationary nodes that were merged. The endpoints of beams formerly connected to the stationary nodes are then reconnected to the resultant node. In some embodiments, when the width of a beam is reduced to below a certain threshold value, the edge occupied by that beam is deleted.

Set of solution frames 204 includes the solution frames 213 generated by convergent search algorithm 203. It is noted that each instance of a solution frame 213 can have more or fewer nodes and more or fewer beams than input frame 211.

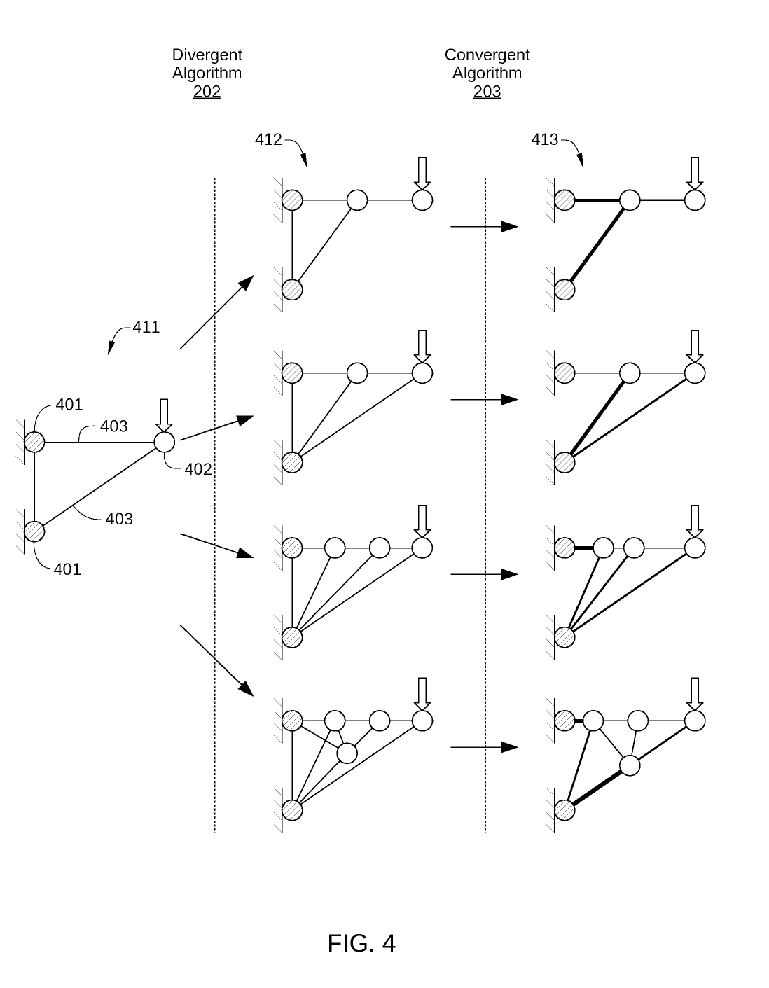

FIG. 4 schematically illustrates process 200, according to various embodiments of the present invention. As shown, an initial frame 411 is introduced, where initial frame 411 includes one or more fixed supports 401, nodes 402, and beams 403. Divergent search algorithm 202 then generates a plurality of candidate frames 412 based on initial frame 411. Various beams 403 and nodes 402 are added to the original geometry of initial frame 411 to generate candidate frames 412. Once a sufficient number of suitable candidate frames 412 have been generated by divergent search algorithm 202, convergent search algorithm 203 optimizes each of candidate frame 412 to generate a plurality of solution frames 413 as shown.

### Synthesizing Frame with Divergent and Convergent Search Algorithms

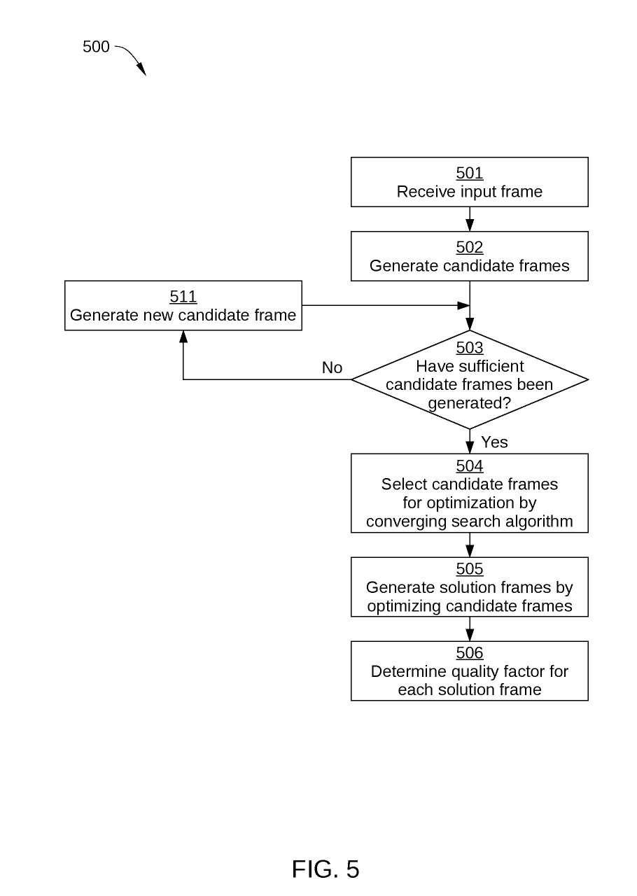

FIG. 5 sets forth a flowchart of method steps for generating one or more designs for a structural frame, according to various embodiments of the present invention. Although the method steps are described in conjunction with the systems of FIGS. 1-4, persons skilled in the art will understand that any system configured to perform the method steps, in any order, is within the scope of the present invention.

As shown, a method 500 begins at step 501, where divergent search algorithm 202 receives input frame 211 and an optimization objective for generating a solution frame 213. In some embodiments, input frame 211 includes an initial geometry with an initial number of nodes and an initial number of beams. In some embodiments, input frame 211 includes physical constraint information associated with a proposed structural frame. For example, in some embodiments, the physical constraint information includes one or more of a static physical load on the structural frame, a dynamic physical load on the structural frame, a thermal load on the structural frame, and a proscribed region in which neither a node or a beam of the structural frame can be located.

In step 502, divergent search algorithm 202 generates a one or more candidate frames 212. In some embodiments, divergent search algorithm 202 generates candidate frames 212 by making at least one random change to a topology input frame 211 or a previously generated candidate frame 212 that is derived from input frame 211. In some embodiments, divergent search algorithm 202 generates candidate frames 212 by adding at least one new node and/or one or more new beams to the geometry of either input frame 211 or a previously generated candidate frame 212 that is derived from input frame 211.

In step 503, divergent search algorithm 202 determines whether sufficient candidate frames 212 that meet one or more predetermined criteria have been generated. For example, divergent search algorithm 202 may make such a determination based on one or more quality metrics, as described above in conjunction with FIG. 2. When divergent search algorithm 202 determines that a sufficient number of candidate frames 212 of sufficient quality have been generated, method 500 proceeds to step 504. When divergent search algorithm 202 determines that an insufficient number of candidate frames 212 of sufficient quality have been generated, method 500 proceeds to step 511.

In step 504, divergent search algorithm 202 selects candidate frames 212 for optimization by convergent search algorithm 203. In some embodiments, divergent search algorithm 202 selects the entire population of candidate frames 212 for subsequent optimization. In other embodiments, divergent search algorithm 202 selects a portion of candidate frames 212 for optimization. In such embodiments, the candidate frames 212 may be selected based on one or more quality metrics as described above.

In step 505, convergent search algorithm 203 generates a solution frame 213 for each candidate frame that has been optimized in step 504.

In step 506, convergent search algorithm 203 determines a quality factor for each solution frame 213. The quality factor determined for each solution frame 213 enables a user to quantitatively compare each solution frame 213 to each of the other solution frames 213 with respect to the optimization objective. That is, how well each solution frame 213 achieves the design goal (such as minimization of weight, frequency, cost, etc) represented by the objective function can be compared to each of the other solution frames.

In step 511, which is performed in response to divergent search algorithm 202 determining that an insufficient number of candidate frames 212 of sufficient quality have been generated, divergent search algorithm 202 generates a new candidate frame and method 500 returns back to step 503. As described above in conjunction with FIG. 2, divergent search algorithm 202 can generate a new candidate frame by mutating a parent frame. Divergent search algorithm 202 then adds the newly mutated candidate frame to the current population of candidate frames.

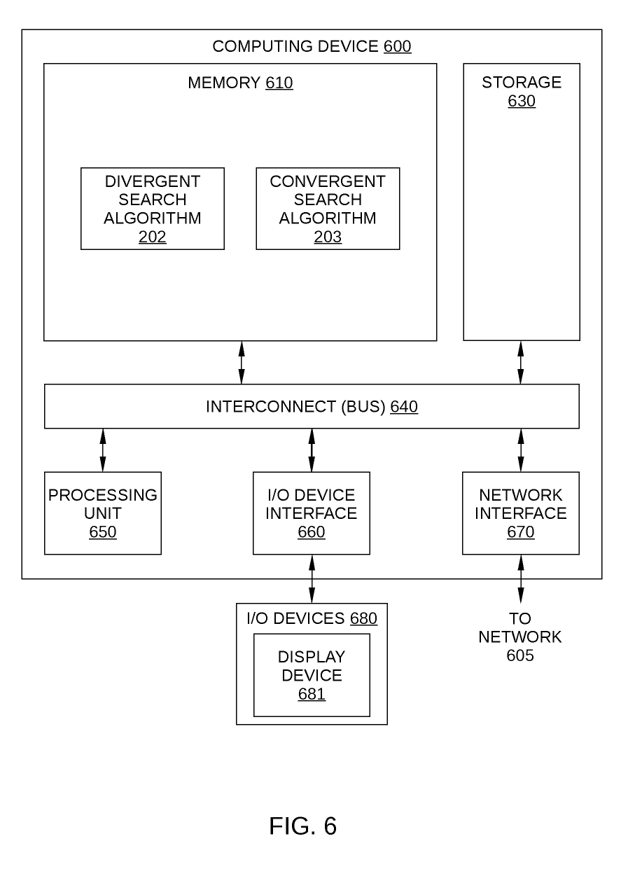

FIG. 6 is a block diagram of a computing device 600 configured to implement one or more aspects of the present invention. Computing device 600 may be a desktop computer, a laptop computer, a tablet computer, or any other type of computing device configured to receive input, process data, generate control signals, and display images. Computing device 600 is configured to execute divergent search algorithm 202, convergent search algorithm 203, and/or other suitable software applications, which reside in a memory 610. It is noted that the computing device described herein is illustrative and that any other technically feasible configurations fall within the scope of the present invention.

As shown, computing device 600 includes, without limitation, an interconnect (bus) 640 that connects a processing unit 650, an input/output (I/O) device interface 660 coupled to input/output (I/O) devices 680, memory 610, a storage 630, and a network interface 670. Processing unit 650 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 650 may be any technically feasible hardware unit capable of processing data and/or executing software applications, divergent search algorithm 202, convergent search algorithm 203, and/or other suitable software applications. Further, in the context of this disclosure, the computing elements shown in computing device 600 may correspond to a physical computing system (e.g., a system in a data center) or may be a virtual computing instance executing within a computing cloud.

I/O devices 680 may include devices capable of providing input, such as a keyboard, a mouse, a touch-sensitive screen, and so forth, as well as devices capable of providing output, such as a display device 681. Additionally, I/O devices 680 may include devices capable of both receiving input and providing output, such as a touchscreen, a universal serial bus (USB) port, and so forth. I/O devices 680 may be configured to receive various types of input from an end-user of computing device 600, and to also provide various types of output to the end-user of computing device 600, such as one or more graphical user interfaces (GUI), displayed digital images, and/or digital videos. In some embodiments, one or more of I/O devices 680 are configured to couple computing device 600 to a network 605.

Network 605 may be any technically feasible type of communications network that allows data to be exchanged between computing device 600 and external entities or devices, such as a smart device, a wearable smart device, a web server, or another networked computing device (not shown). For example, network 605 may include a wide area network (WAN), a local area network (LAN), a wireless (WiFi) network, a Bluetooth network and/or the Internet, among others.

Memory 610 may include a random access memory (RAM) module, a flash memory unit, or any other type of memory unit or combination thereof. Processing unit 650, I/O device interface 660, and network interface 670 are configured to read data from and write data to memory 610. Memory 610 includes various software programs that can be executed by processor 650 and application data associated with said software programs, including divergent search algorithm 202, convergent search algorithm 203, and/or other suitable software applications.

In sum, embodiments of the present invention provide techniques for synthesizing a design for a mechanical structure using a divergent algorithm in conjunction with a convergent algorithm. A divergent search algorithm is employed to generate a plurality of candidate frames that are based on an input frame. The divergent search algorithm attempts to randomly alter the candidate frames from the input frame to more fully explore the objective function to be minimized. Each of the candidate frames is then optimized by a convergent search algorithm to generate a solution frame that corresponds to a local minimum of the objective function. In some embodiments, the divergent search algorithm generates a candidate frame by mutating a previously generated candidate frame. In addition, in some embodiments, the convergent search algorithm is configured to remove nodes and/or edges during optimization of the candidate frames under certain conditions, which simplifies the resultant solution frame so generated.

At least one advantage of the disclosed techniques is that a structural frame produced via a generative design process can have significantly fewer nodes that the input frame used to initiate the process. Consequently, the structural frame so produced can be less complex in appearance and easier to fabricate. A further advantage is that the structural frame so produced is more likely than a structural frame generated with conventional generative design techniques to approximate a global minimum of the objective function used to optimize the frame design. Thus, for a specific input frame that is optimized for minimal weight, a structural frame produced by the disclosed techniques will be lighter-weight than a structural frame generated with conventional generative design techniques.

1. In some embodiments, a computer-implemented method for generating one or more designs for a structural frame comprises: receiving an input frame and an optimization objective that indicates a design goal for the one or more designs; based on the input frame, generating multiple candidate frames via a divergent search algorithm; based on the optimization objective, generating a different solution frame for each candidate frame via a convergent search algorithm; and determining a quality factor for each solution frame that enables a quantitative comparison with respect to the optimization objective of the solution frame with each other solution frame.

2. The computer-implemented method of claim 1, wherein generating the multiple candidate frames via the divergent search algorithm comprises: mutating the input frame to generate multiple new frames; and for each new frame of the multiple new frames, optimizing the new frame via the convergent search algorithm based on the optimization objective to generate one of the multiple candidate frames.

3. The computer-implemented method of clause 1 or 2, wherein the convergent search algorithm comprises a gradient-based optimization algorithm.

4. The computer-implemented method of any of clauses 1-3, wherein determining the quality factor for each solution frame comprises quantifying a physical characteristic of the solution frame, wherein the physical characteristic is associated with the optimization objective.

5. The computer-implemented method of any of clauses 1-4, wherein quantifying a physical characteristic of the solution frame comprises summing a value associated with the physical characteristic for a beam included in the optimized candidate geometry with the value for each other beam included in the optimized candidate geometry.

6. The computer-implemented method of any of clauses 1-5, further comprising performing a finite element analysis on the solution frame to generate the value, for each beam included in the solution frame, that is associated with the physical characteristic.

7. The computer-implemented method of any of clauses 1-6, wherein generating the multiple candidate frames via the divergent search algorithm comprises adding at least one of a new node and a new beam to a geometry of one of the input frame or a frame that is derived from the input frame.

8. The computer-implemented method of any of clauses 1-7, wherein generating the multiple candidate frames via the divergent search algorithm comprises making at least one change to a topology of either the input frame or a candidate frame that is derived from the input frame to generate a new frame, wherein the change is determined via a process that is not restricted to selection based on a quality metric of the input frame, the candidate frame, or the new frame.

9. The computer-implemented method of any of clauses 1-8, wherein the optimization objective is based on at least one physical characteristic of the structural frame.

10. The computer-implemented method of any of clauses 1-9, wherein the at least one physical characteristic of the mechanical structure comprises a value for one element of the structural frame summed with a respective value for each other element of the structural frame.

11. In some embodiments, a non-transitory computer readable medium stores instructions that, when executed by a processor, cause the processor to perform the steps of: receiving an input frame and an optimization objective that indicates a design goal for the one or more designs; based on the input frame, generating multiple candidate frames via a divergent search algorithm; based on the optimization objective, generating a different solution frame for each candidate frame via a convergent search algorithm; and determining a quality factor for each solution frame that enables a quantitative comparison with respect to the optimization objective of the solution frame with each other solution frame.

12. The non-transitory computer readable medium of clause 11, wherein the input frame comprises a fixed support that is constrained to a pre-defined location, a node that is not constrained to a specific location, and one beam that is directly coupled to at least one of the fixed support and the node.

13. The non-transitory computer readable medium of clauses 11 or 12, wherein receiving the input frame comprises receiving an initial geometry having an initial number of nodes and an initial number of beams.

14. The non-transitory computer readable medium of any of clauses 11-13, wherein at least one solution frame has a number of nodes that is different from the initial number of nodes.

15. The non-transitory computer readable medium of any of clauses 11-14, wherein receiving the input frame comprises receiving constraint information associated with the structural frame.

16. The non-transitory computer readable medium of any of clauses 11-15, wherein the constraint information includes at least one of a static physical load on the structural frame, a dynamic physical load on the structural frame, a thermal load on the structural frame, and a proscribed region within which neither a node nor a beam of the structural frame can be located.

17. The non-transitory computer readable medium of any of clauses 11-16, wherein generating the multiple candidate frames via the divergent search algorithm comprises adding at least one of a new node and a new beam to a geometry of one of the input frame or a frame that is derived from the input frame.

18. The non-transitory computer readable medium of any of clauses 11-17, wherein generating the multiple candidate frames via the divergent search algorithm comprises making at least one change to a topology of either the input frame or a candidate frame that is derived from the input frame to generate a new frame, wherein the change is determined via a process that is not restricted to selection based on a quality metric of the input frame, the candidate frame, or the new frame.

19. The non-transitory computer readable medium of any of clauses 11-18, wherein the optimization objective is based on at least one physical characteristic of the structural frame.

20. In some embodiments, a system comprises: a memory that stores instructions; and a processor that is coupled to the memory and is configured to perform the steps of, upon executing the instructions: receiving an input frame and an optimization objective that indicates a design goal for the one or more designs; based on the input frame, generating multiple candidate frames via a divergent search algorithm; based on the optimization objective, generating a different solution frame for each candidate frame via a convergent search algorithm; and determining a quality factor for each solution frame that enables a quantitative comparison with respect to the optimization objective of the solution frame with each solution frame.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of application data, content servers, and client devices, persons skilled in the art will appreciate that the systems and techniques described herein are applicable to other types of application data, content servers, and client devices. The foregoing description and drawings are, accordingly, to be regarded in an illustrative rather than a restrictive sense.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for generating one or more designs for a structural frame, the method comprising:
receiving an input frame and an optimization objective that indicates a design goal for the one or more designs;
based on the input frame, generating multiple candidate frames via a divergent search algorithm;
based on the optimization objective, generating a different solution frame for each candidate frame via a convergent search algorithm; and
determining a quality factor for each solution frame that enables a quantitative comparison with respect to the optimization objective of the solution frame with each other solution frame.

2. The computer-implemented method of claim 1, wherein generating the multiple candidate frames via the divergent search algorithm comprises:
mutating the input frame to generate multiple new frames; and
for each new frame of the multiple new frames, optimizing the new frame via the convergent search algorithm based on the optimization objective to generate one of the multiple candidate frames.

3. The computer-implemented method of claim 1, wherein the convergent search algorithm comprises a gradient-based optimization algorithm.

4. The computer-implemented method of claim 1, wherein determining the quality factor for each solution frame comprises quantifying a physical characteristic of the solution frame, wherein the physical characteristic is associated with the optimization objective.

5. The computer-implemented method of claim 4, wherein quantifying a physical characteristic of the solution frame comprises summing a value associated with the physical characteristic for a beam included in the optimized candidate geometry with the value for each other beam included in the optimized candidate geometry.

6. The computer-implemented method of claim 4, further comprising performing a finite element analysis on the solution frame to generate the value, for each beam included in the solution frame, that is associated with the physical characteristic.

7. The computer-implemented method of claim 1, wherein generating the multiple candidate frames via the divergent search algorithm comprises adding at least one of a new node and a new beam to a geometry of one of the input frame or a frame that is derived from the input frame.

8. The computer-implemented method of claim 1, wherein generating the multiple candidate frames via the divergent search algorithm comprises making at least one change to a topology of either the input frame or a candidate frame that is derived from the input frame to generate a new frame, wherein the change is determined via a process that is not restricted to selection based on a quality metric of the input frame, the candidate frame, or the new frame.

9. The computer-implemented method of claim 1, wherein the optimization objective is based on at least one physical characteristic of the structural frame.

10. The computer-implemented method of claim 9, wherein the at least one physical characteristic of the mechanical structure comprises a value for one element of the structural frame summed with a respective value for each other element of the structural frame.

11. A non-transitory computer readable medium storing instructions that, when executed by a processor, cause the processor to perform the steps of:
receiving an input frame and an optimization objective that indicates a design goal for the one or more designs;
based on the input frame, generating multiple candidate frames via a divergent search algorithm;
based on the optimization objective, generating a different solution frame for each candidate frame via a convergent search algorithm; and
determining a quality factor for each solution frame that enables a quantitative comparison with respect to the optimization objective of the solution frame with each other solution frame.

12. The non-transitory computer readable medium of claim 11, wherein the input frame comprises a fixed support that is constrained to a pre-defined location, a node that is not constrained to a specific location, and one beam that is directly coupled to at least one of the fixed support and the node.

13. The non-transitory computer readable medium of claim 11, wherein receiving the input frame comprises receiving an initial geometry having an initial number of nodes and an initial number of beams.

14. The non-transitory computer readable medium of claim 13, wherein at least one solution frame has a number of nodes that is different from the initial number of nodes.

15. The non-transitory computer readable medium of claim 11, wherein receiving the input frame comprises receiving constraint information associated with the structural frame.

16. The non-transitory computer readable medium of claim 15, wherein the constraint information includes at least one of a static physical load on the structural frame, a dynamic physical load on the structural frame, a thermal load on the structural frame, and a proscribed region within which neither a node nor a beam of the structural frame can be located.

17. The non-transitory computer readable medium of claim 11, wherein generating the multiple candidate frames via the divergent search algorithm comprises adding at least one of a new node and a new beam to a geometry of one of the input frame or a frame that is derived from the input frame.

18. The non-transitory computer readable medium of claim 11, wherein generating the multiple candidate frames via the divergent search algorithm comprises making at least one change to a topology of either the input frame or a candidate frame that is derived from the input frame to generate a new frame, wherein the change is determined via a process that is not restricted to selection based on a quality metric of the input frame, the candidate frame, or the new frame.

19. The non-transitory computer readable medium of claim 11, wherein the optimization objective is based on at least one physical characteristic of the structural frame.

20. A system, comprising:
a memory that stores instructions; and
a processor that is coupled to the memory and is configured to perform the steps of, upon executing the instructions:
receiving an input frame and an optimization objective that indicates a design goal for the one or more designs;
based on the input frame, generating multiple candidate frames via a divergent search algorithm;
based on the optimization objective, generating a different solution frame for each candidate frame via a convergent search algorithm; and
determining a quality factor for each solution frame that enables a quantitative comparison with respect to the optimization objective of the solution frame with each solution frame.
